(19) United States
(12) Patent Application Publication
(10) Pub. No.: US 2010/0225470 A1
(43) Pub. Date: Sep. 9, 2010

(54) ENTITY IDENTIFICATION AND INFORMATION RETRIEVAL WITH A MOBILE DEVICE

(76) Inventors: Manish Marwah, Mountain View, CA (US); Ratnesh Kurnar Sharma, Fremont, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/399,366

(22) Filed: Mar. 6, 2009

(51) Int. Cl. G08B 1/08

(52) U.S. Cl. 340/539.13

(57) ABSTRACT

A mobile device for obtaining information pertaining to at least one entity in a room containing multiple entities connected to a network. The location of the mobile device with respect to a map of the room is identified and the identification of the at least one entity is determined based upon a correlation of the identified location of the mobile device with respect to the map of the room. The mobile device is connected to the network and information pertaining to the at least one entity is obtained through the connection with the network.

### CROSS-REFERENCE TO RELATED APPLICATION

The present application has the same Assignee and shares some common subject matter with U.S. Pat. No. 6,977,587, issued on Dec. 20, 2005, to Salil Pradhan et al., the disclosure of which is hereby incorporated by reference in its entirety.

### BACKGROUND

A data center is defined as a location, for instance a room, that houses computer systems arranged in a number of racks. State-of-the-art data centers have been known to contain up to tens of thousands of entities, such as servers, switches, computer room air conditioning (CRAC) units, and power distribution units (PDUs). While most entities are capable of being remotely monitored and managed, some tasks require the physical presence of an administrator. These include adding/replacing/moving equipment or parts, assessment of a specific aspect of a data center, for example, thermal assessment, and, modification of a sensitive configuration parameter that cannot be changed remotely and requires direct physical connectivity to a device, for instance, through a directly connected console. Furthermore, locating an entity in a data center has been known to be a tedious and error-prone process considering that data centers are often huge facilities, up to a hundred thousand sq. ft., with similar looking rows of racks.

Given the problems in data centers that require the physical presence of an administrator at a particular entity, the administrator needs to be able to identify the location and identity of the entities. Currently, administrators rely on information contained in maps of the data centers to direct them to the desired entities. In addition, the entities are often equipped with features such as radio frequency identification (RFID) tags, barcodes, labels, or other types of identification communication devices. As such, for instance, once the administrator has reached a general location of a desired entity, the administrator is able to identify the desired entity through either manual or automatic entry of the entity identification into a laptop or a handheld device.

There are, however, a number of problems associated with the use of such features to enable identification of the entities. For instance, the entities in data centers are often non-uniform and thus, the entities may be equipped with different types of features. Thus, the administrator and/or the laptop or handheld device must be able to identify the different types of features. As another example, the addition of the features is typically a time consuming task, which increases costs associated with setting up and operating data centers. As a further example, because the features are manually placed or programmed, the use of the features is often prone to human errors.

### BRIEF DESCRIPTION OF THE DRAWINGS

Embodiments are illustrated by way of example and not limited in the following figure(s), in which like numerals indicate like elements, in which:

FIG. 1 illustrates a perspective view of a mobile device, according to an embodiment of the invention;

FIG. 2A depicts a simplified top view of a room containing a plurality of CRAC units and racks and a graphical representation of the mobile device depicted in FIG. 1, according to an embodiment of the invention;

FIG. 2B depicts a simplified front view of a rack containing a plurality of entities, in which, at least one of the plurality of entities is an entity of interest, according to an embodiment of the invention;

FIG. 3 illustrates a flow diagram of a method of implementing a mobile device to obtain information pertaining to one or more entities in a room containing a plurality of entities, according to an embodiment of the invention; and

FIG. 4 illustrates a block diagram of a computing apparatus configured to implement the method depicted in FIG. 3, according to an embodiment of the invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures are not described in detail so as not to unnecessarily obscure the description of the embodiments.

Disclosed herein is a mobile device configured to obtain information pertaining to at least one entity in a room containing a plurality of entities and a method for implementing the mobile device to obtain the information. The at least one entity may be at least one of a server, PDU, CRAC unit, network switch or other device that is connected to a network, for instance a local area network (LAN) in the room. In one example, the mobile device is configured to communicate with the at least one entity through the LAN to obtain the information directly from the at least one entity. In another example, the entities are configured to communicate information to one or more access devices, such as, servers, data stores, etc., and the mobile device is configured to communicate with the access device through the LAN to obtain the information from the access device(s).

As discussed in greater detail herein below, the mobile device is configured to determine the identity of the at least one entity based upon the proximity of the mobile device to the at least one entity without obtaining identity information directly from the at least one entity or a feature provided on the entity. In other words, the mobile device disclosed herein does not require the entities to be outfitted with specialized features, such as RFID tags, bar codes, labels, infrared, or Bluetooth™ transmitters or otherwise be modified to interface with the mobile device, in order to identify a particular entity. As such, through implementation of the mobile device and method disclosed herein, many of the problems associated with conventional entity tracking arrangements may substantially be obviated.

In addition, the mobile device may be employed to identify the location of a specific entity in the room and to guide a user to the location of the specific entity.

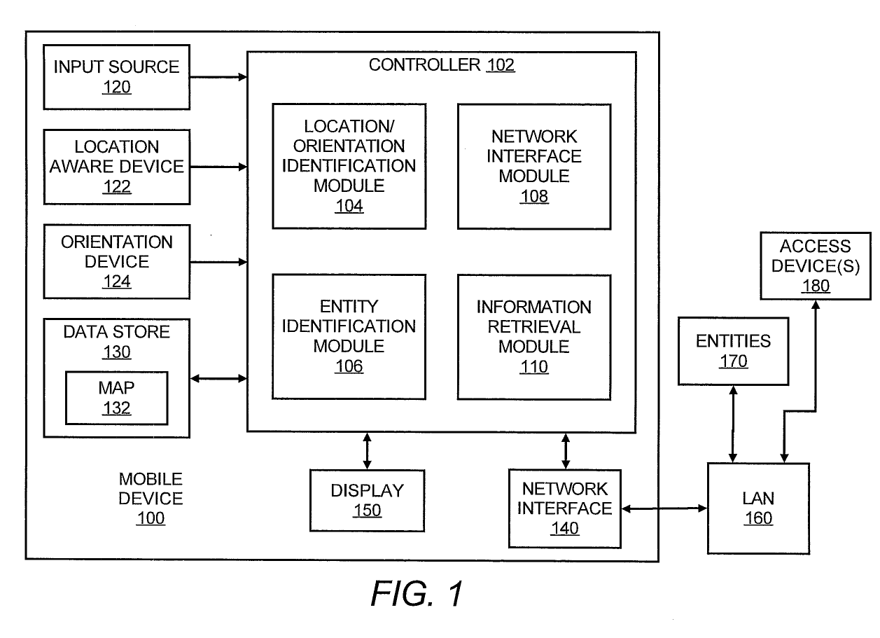

With reference first to FIG. 1, there is shown a mobile device 100 for obtaining information pertaining to at least one entity in a room containing a plurality of entities, according to an embodiment. It should be understood that the mobile device 100 depicted in FIG. 1 may include additional components and that some of the components described herein may be removed and/or modified without departing from a scope of the mobile device 100.

Generally speaking, the mobile device 100 may comprise a portable, handheld device that a user may implement to access an information source over a network to obtain information pertaining to one or more of a plurality of entities. The information source may comprise the entity itself or an access device configured to obtain information from one or more of the entities. As such, the mobile device 100 may be embodied as or implemented in a laptop computer, a personal digital assistant, a cellular telephone, etc.

As depicted in FIG. 1, the mobile device 100 includes a controller 102, which contains a location/orientation identification module 104, an entity identification module 106, a network interface module 108, and an information retrieval module 110. The mobile device 100 is also depicted as including an input source 120, a location aware device 122, an orientation device 124, a data store 130, a network interface 140, and a display 150. Although the input source 120, location aware device 122, orientation device 124, data store 130, network interface 140, and display 150 have been depicted as being integral with the mobile device 100, it should be understood that one or more of these components may be comprise separate components from the mobile device 100 without departing from a scope of the mobile device 100.

According to an example, the controller 102 comprises a hardware device, such as, a circuit or multiple circuits arranged on a board. According to another example, the controller 102 comprises software comprising code stored, for instance, in a volatile or non-volatile memory, such as DRAM, EEPROM, MRAM, flash memory, floppy disk, a CD-ROM, a DVD-ROM, or other optical or magnetic media, and the like. In this example, the controller 102 comprises a software module stored in a memory, such as, the data store 130. According to a further example, the controller 102 comprises a combination of hardware and software modules.

The controller 102 receives instructions from a user through the input source 120, which may comprise a user interface through which a user may input the instructions into the mobile device 100, such as a touchscreen display, a keypad, or other user input device. In addition, the controller 102 receives location information from the location aware device 122, which may comprise a global positioning system (GPS) device or other suitable device for determining its relative location. By way of example, the location aware device 122 may comprise the location aware device described in U.S. Pat. No. 6,977,587. In this example, the room may be equipped with additional devices as described in that patent to enable the location of the location aware device 122 to be determined through triangulation.

The controller 102 may receive orientation information from the orientation device 124. The orientation device 124 is considered optional because in various instances the orientation of the mobile device 100 need not be determined as discussed below. In instances where the orientation device 124 is implemented, the orientation device 124 comprises at least one of a compass, an accelerometer, and a height measurement device, such as a device configured to employ sonar or laser technology to measure the height of the mobile device 100.

According to an example, the data store 130 contains a map 132 of a room, such as, a data center, that includes the identifications and locations of the entities 170, such as, servers, hard drives, switches, CRAC units, PDU's, etc., contained in the room. In another example, the controller 102 accesses the map 132 from a source that the controller 102 may access through the network interface 140 over a local area network (LAN) 160.

The controller 102 invokes or implements the location/orientation identification module 104 to determine the position and, in certain instances, the orientation of the mobile device 100 with respect to the room. More particularly, for instance, the controller 102 invokes or implements the location/orientation identification module 104 to compare the location of the mobile device 100 with respect to the map 132 to thereby determine the position of the mobile device 100 in the room.

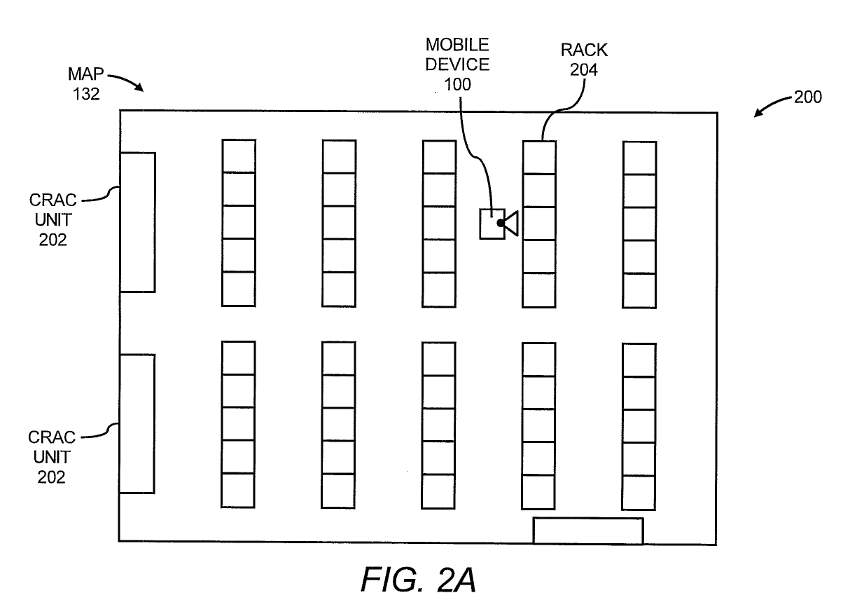

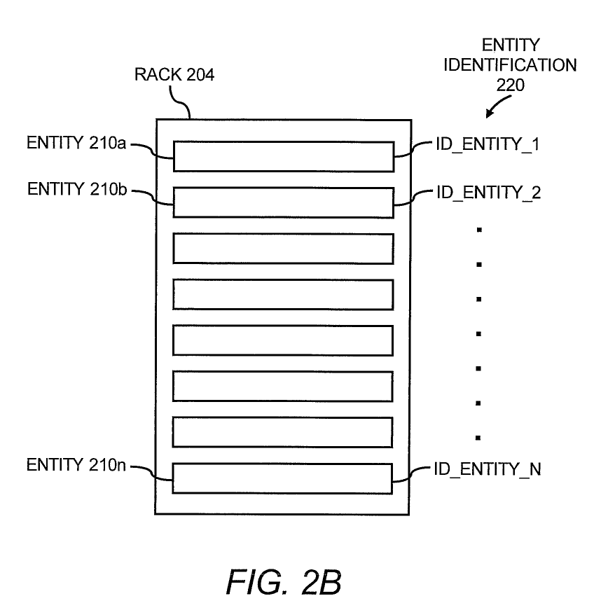

An example of a map 132 of a room, such as, a data center, is depicted in FIG. 2A. FIG. 2A, more particularly, depicts a simplified top view of a room 200 containing a plurality of CRAC units 202 and racks 204. It should be understood that the depiction of the map 132 in FIG. 2A is for illustrative purposes and should not be construed as limiting the invention in any respect. According to an example, the map 132 comprises a data representation of the room 200 and its entities 170, which may be depicted graphically, in a table, or otherwise stored as data.

Also shown in the room 200 is a graphical representation of the mobile device 100 at its current location with respect to a particular rack 204 in the room 200, which may be displayed on the display 150. Thus, for instance, the controller 102 may employ the correlation of the mobile device 100 position and a nearest rack 204 to determine that an entity 170 of interest is contained in that nearest rack 204. As described below, the controller 102 may further refine identification of the entity 170 of interest through implementation of the information received from the orientation device 124.

More particularly, in instances where the orientation device 124 is implemented, the controller 102 invokes or implements the location/orientation identification module 104 to determine the orientation of the mobile device 100. In these instances, the controller 102 invokes or implements the location/orientation identification module 104 to determine the orientation of the mobile device 100 based upon orientation information, such as, height, direction, and angle of the mobile device 100, received from the orientation device 124. Thus, by way of example, a user may point to the mobile device 100 towards the entity 170 of interest and the controller 102 may further identify the entity 170 of interest based upon the determined orientation of the mobile device 100.

An example of a rack 204 containing a plurality of entities 210a-210n is depicted in FIG. 2B, which depicts a simplified front view of the rack 204 containing the plurality of entities 210a-210n. It should be understood that the depiction of the rack 204 in FIG. 2B is for illustrative purposes and should not be construed as limiting the invention in any respect. According to an example, the depiction of the rack 204 comprises a data representation of the rack 204 and its entities 210a-210n, which may be depicted graphically, in a table, or otherwise stored as data. As such, for instance, the rack 204 may be displayed on the display 150.

The controller 102 is configured to invoke or implement the entity identification module 106 to identify which of the entities 210a-210n are of interest to a user. In other words, the entity identification module 106 is configured to determine which of the entities 210a-210n the user desires to receive information.

According to an example, the entity identification module 106 may identify all of the entities 210a-210n contained in the rack 204 in the closest proximity to the mobile device 100 as comprising the entities of interest. In another example, the entity identification module 106 may determine to which of the entities 210a-210n the mobile device 100 is currently being pointed and to identify that entity or entities 210a-210n as the entity or entities 170 of interest. In a further example, a graphical representation of the rack 204 and the entities 210a-210n that are in the closest proximity to the mobile device 100 may be displayed to a user on the display 150. In this example, the user may select one or more of the entities 210a-210n depicted on the display 150 that correspond to the actual entities contained in the rack 204 for which information is desired. Thus, for instance, the user may select the one or more entities 210a-210n through use of the input source 120, which may comprise a touchscreen input source.

In any of the examples above, and as further shown in FIG. 2B, the map 132, to which the illustration of the rack 204 forms a part, also includes identification information 220 of the entities 170 contained in the room 200. The identification information 220 of the entities 170 may comprise, for instance, substantially unique identifications of the entities 170, such as, serial numbers, IP addresses, etc. In addition, the identification information 220 may also include location information, such as, X-Y coordinates, row-aisle coordinates, etc., of the entities 170.

Through implementation of the location/orientation identification module 104 and the entity identification module 106, the controller 102 may thus determine the identities of the one or more entities 170 of interest without obtaining the identification information directly from the one or more entities 170. As such, the entities 170 need not be equipped with physical labels or otherwise be equipped to communicate locally with the mobile device 100.

The controller 102 is configured to implement the network interface module 108 to connect to the LAN 160 through the network interface 140. The LAN 160 may comprise a local area network in the room to which the entities 170 are connected. Thus, for instance, the entities 170 may be configured to communicate data over the LAN 160, such as, state information, workload instructions, or other data to other entities 170 in the room or to entities 170 outside of the room. In one example, the network interface 140 comprises a wireless interface device and a wireless router or hub may be connected to the LAN 160 to enable access the controller 102 with access to the LAN 160 through use of any suitable wireless protocol. Access to the LAN 160 may require the controller 102 to be authenticated to thereby prevent unauthorized access into the LAN 160. In another example, the network interface 140 comprises a wired interface device configured to connect to the LAN 160 through use of any suitable wired connection protocol.

The controller 102 is configured to implement the information retrieval module 110 to communicate with at least one of the one or more entities 170 of interest and one or more access devices 180 to retrieve information pertaining to the one or more entities 170 of interest. The information may include, for instance, information related to operational and configuration parameters, information related to thresholds and reference parameters, information related to applications, information related to computing, for instance CPU or memory, as well as information related to other parameters such as storage, network, cooling infrastructure, and power delivery infrastructure, etc. In addition to current state information, the entities 170 and/or the access devices 180 may keep historical state information, which the controller 102 may also retrieve from either or both of the entities 170 and the access devices 180.

In instances where the access device(s) 180 are employed in the room, the access device(s) 180 may comprise, for instance, servers, data stores, etc., connected to the LAN 160 and configured to receive information from one or more of the entities 170. In one regard, the access device(s) 180 generally comprise data repositories that the controller 102 may access to obtain information of the entities 170. In instances where the access device(s) 180 are omitted, the controller 102 is configured to connect directly with the entities 170 to obtain the information directly therefrom.

The controller 102 may store the information retrieved from either or both of the entities 170 and the access device(s) 180 in the data store 130. In addition, the controller 102 may display the retrieved information on the display 150. The received information may be combined with relevant or contextual information previously stored in the data store 130. For instance, the relevant or contextual information is overlaid on a sectional map of that location of the room.

The display 150 may be configured by the user based on the intended use. The following are some of the configuration options. The user may specify a view, where the view contains information in a specific format that the user wishes to be displayed. The view may be predefined based on the type of information to be displayed, for example a network view, a performance view, a power view, or a cooling view may be chosen. The view may also be based on the amount of detail and the level of information to be displayed, for example a CIO view, or an operator view. According to an example, the controller 102 is configured to submit queries to either or both of the entities 170 and the access devices 180 based upon the display settings.

The controller 102 may display information received based on user preferences. The user preferences may be set on a per-user, per-entity type or per-information type basis. The mobile device 100 may use a graphical/textual display 150 and/or an audio output depending on the capability of the mobile device 100. The user may also specify rules to determine the information displayed, for example, only information related to abnormal behavior of a certain severity level may be displayed. The controller 102 may be configured to continuously query the one or more entities 170 of interest, at a user specified frequency, to, for instance, identify a dynamic behavior of the one or more entities 170 of interest.

After reviewing the information, the user may perform a number of tasks such as “drilling” deeper on some part of the information in order to receive greater detail. For instance, the controller 102 may submit further queries to the one or more entities 170 of interest to obtain the additional information. By way of particular example, the one or more entities 170 of interest may identify pointers to other information that may also be available at the one or more entities 170 of interest, such as significant events from the past few days, or, historical information, which the user may choose to retrieve.

The controller 102 may also be configured to display information aggregated from multiple sources. By way of example, aggregation may be based on 1) physical locality, for instance, rack level, row level, zone level, floor level or data center level, 2) a specific function, for instance, computing, cooling, power, 3) event type and their severity, for instance, all alarms or all warnings, 4) configuration parameters, for instance, all configuration parameters related to cooling and power.

The mobile device 100 may also be configured to provide navigation assistance within the room. For instance, the mobile device 100 may be configured to identify a suitable path from a current location to the location of another entity 170. The display 150 may be employed to display the path, which may be depicted to overlay the map 132 of the room. The directions to reach the another entity 170 may also be relayed to the user via audio information. By way of particular example, the another entity 170 may comprise an entity 170 that is related to a present entity 170 of interest, for instance, as may occur when the present entity 170 and the another entity 170 provide aggregated information to the mobile device 100.

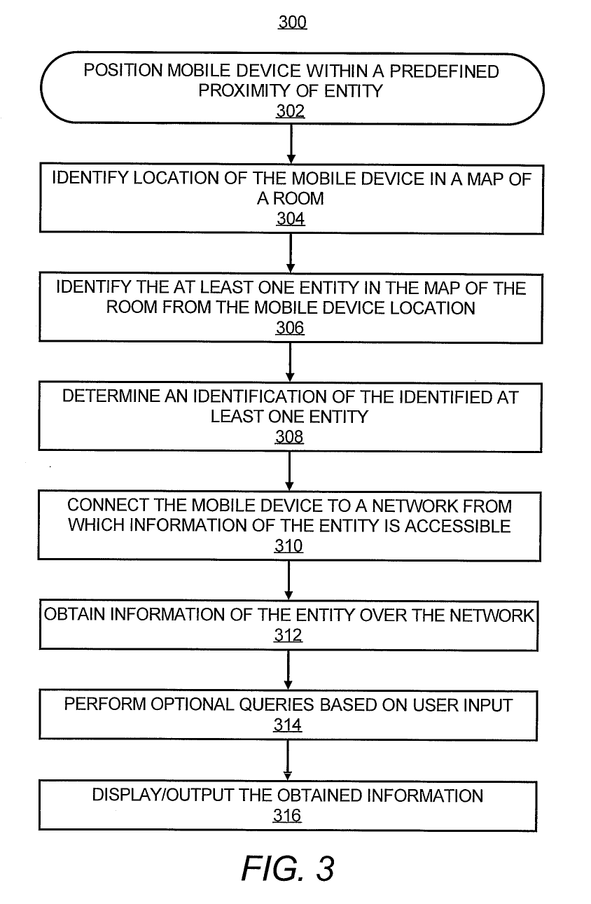

Turning now to FIG. 3, there is shown a flow diagram of a method 300 of implementing a mobile device 100 to obtain information pertaining to one or more entities 170 in a room containing a plurality of entities 170, according to an example. It should be apparent to those of ordinary skill in the art that the method 300 represents a generalized illustration and that other steps may be added or existing steps may be removed, modified or rearranged without departing from a scope of the method 300. In addition, the method 300 is described with particular reference to FIGS. 1, 2A and 2B by way of example and not of limitation.

At step 302, the mobile device 100 is placed within a predefined proximity of at least one entity 170 of interest, which comprises the one or more entities 170 about which the user seeks to obtain information. In other words, at step 302, a user may position the mobile device 100 in relatively close proximity, for instance, within a few feet, or a few inches, of the at least one entity 170 of interest. In addition, or alternatively, the user may position the mobile device 100 directly in front of the at least one entity 170 of interest.

At step 304, the controller 102 identifies the location of the mobile device 100 with respect to the map 132. As discussed above, the controller 102 receives location information from the location aware device 122 and invokes or implements the location/orientation identification module 104 to determine the location of the mobile device 100 with respect to the map 132, which is either stored in the data store 130 or stored on another network-accessible location. In addition, the map 132 contains identifications and locations of the plurality of entities 170 in a room 200.

At step 306, the controller 102 identifies the at least one entity 170 of interest in the map 132 based upon the location of the mobile device 100 with respect to the entities 170 contained in the map 132. In one example, the controller 102 identifies all of the entities 170 contained in a rack 204 that is in the closest proximity to the mobile device 100. In another example, the controller 102 identifies one or more of the entities 170 contained in the rack 204 based upon a detected orientation of the mobile device 100, for instance, the one or more entities 170 to which the mobile device 100 is pointing. In a further example, the controller 102 receives input from a user pertaining to the one or more entities 170 through, for instance, an identification by the user of the one or more entities 170 of interest displayed on the display 150.

At step 308, the controller 102 determines an identification(s) 220 of the at least one entity 170 of interest. The identification information 220 of the entities 170 may be stored with the map 132 and the controller 102 may access the map 132 to determine the identification(s) 220 of the at least one entity 170 of interest.

At step 310, the controller 102 connects to the LAN 160 through the network interface 140. The network interface 140 may enable a wireless connection to the LAN 160 through one or more access points, such as, a wireless router or hub. Alternatively, the network interface 140 may enable a wired connection to the LAN 160.

At step 312, the controller 102 receives information pertaining to the at least one entity 170 of interest via the network based upon the identification(s) 220 of the at least one entity 170. In one example, the controller 102 receives the information directly from the at least one entity 170. In another example, the entities 170 are configured to communicate information to one or more access devices 180 and the controller 102 receives the information from the one or more access devices 180.

According to an example, the controller 102 may be programmed with policies specific to user preferences that provide information at varying levels of granularity. In this example, the controller 102 may filter the information according to a number of relevant criteria in terms of what information is required by the user. By way of example, the controller 102 may be configured to return alerts or alarms if the obtained information indicates that a predetermined parameter, such as, server utilization, server temperature, etc., is exceeded. The controller 102 may also be programmable in that policies may be added ad hoc by the user.

At step 312, the controller 102 may also access aggregated information for a subgroup of the plurality of entities 170 via the LAN 160. In one regard, the aggregated information may provide a better understanding of management concerns in a data center, which may not be available from information about particular entities 170. In addition, the aggregated information may be of greater importance because at a data center level, information pertaining to the entities 170 may have a different significance than at a rack or individual entity level.

At step 314, the controller 102 may optionally submit additional queries to obtain further details relevant to the obtained information. The additional queries may be submitted, for instance, to obtain additional information pertaining to entities 170 related to the at least one entity 170 of interest.

At step 316, the controller 102 is configured to display and/or otherwise output the obtained information. Thus, for instance, the controller 102 may display the obtained information on the display 150, output the obtained information over the LAN 160 to another computing device, etc.

Some or all of the operations set forth in the method 300 may be contained as utilities, programs, or subprograms, in any desired computer accessible medium. In addition, the method 300 may be embodied by computer programs, which may exist in a variety of forms both active and inactive. For example, they may exist as software program(s) comprised of program instructions in source code, object code, executable code or other formats. Any of the above may be embodied on a computer readable medium.

Exemplary computer readable storage devices include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

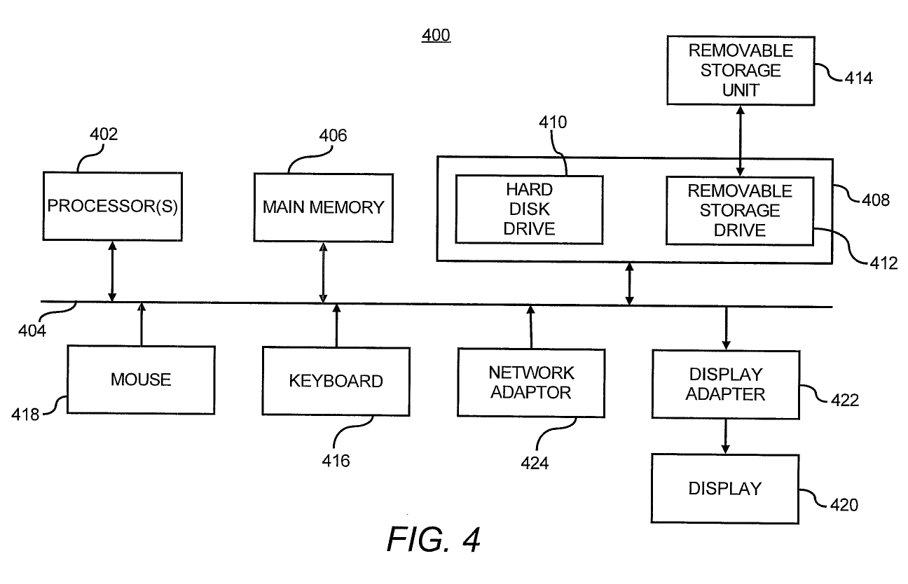

FIG. 4 illustrates a block diagram of a general purpose computing apparatus 400 configured to implement or execute the embodiments described herein, according to an example. In this respect, the computing apparatus 400 may be used as a platform for executing one or more of the functions described hereinabove with respect to the mobile device 100.

The computing apparatus 400 includes a processor 402 that may implement or execute some or all of the steps described in the method 300. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for the method 300 may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

What has been described and illustrated herein is an embodiment along with some of its variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for obtaining information with a mobile device pertaining to at least one entity in a room containing a plurality of entities, said at least one entity being connected to a network, said method comprising:
a) identifying a location of the mobile device with respect to a map of the room, said map containing identifications and locations of the plurality of entities;
b) determining an identification of the at least one entity based upon a correlation of the identified location of the mobile device with respect to the map of the room;
c) connecting the mobile device to the network; and
d) obtaining information in the mobile device pertaining to the at least one entity through the connection with the network.

2. The method according to claim 1, wherein determining the identification of the at least one entity further comprises determining the identification of the at least one entity based solely upon the identified location of the mobile device with respect to the map of the room.

3. The method according to claim 1, further comprising:
positioning the mobile device within a predefined proximity of the at least one entity prior to identifying the location of the mobile device with respect to the map of the room.

4. The method according to claim 1, wherein determining the identification of the at least one entity further comprises determining the identification of the at least one entity that is at least one of in the closest proximity to the mobile device and being pointed to by the mobile device.

5. The method according to claim 1, wherein connecting the mobile device to the network further comprises connecting the mobile device to the network through a wireless connection with the network.

6. The method according to claim 1, wherein identifying a location of the mobile device further comprises automatically identifying a location of the mobile device through implementation of a location tracking system.

7. The method according to claim 1, wherein obtaining information in the mobile device further comprises at least one of obtaining the information directly from the at least one entity and obtaining the information from another entity configured to collect the information pertaining to the at least one device.

8. The method according to claim 1, wherein obtaining the information in the mobile device further comprises obtaining information related to at least one of:
operational parameters, configuration parameters, thresholds, reference parameters, applications, computing, storage, network, cooling infrastructure, power delivery, and infrastructure of the at least one entity.

9. The method according to claim 1, wherein obtaining the information in the mobile device further comprises:
determining an identification of at least one further entity based upon a response to a query for the information;
providing a direction to the user to the at least one further entity; and
repeating steps a) though d) for the at least one further entity.

10. The method according to claim 1, wherein the mobile device comprises a display, and wherein the method further comprises:
providing a graphical representation of a plurality of entities located within the predefined proximity of the at least mobile device on the display;
receiving an input that identifies selection of at least one of the plurality of entities in the graphical representation of the plurality of entities; and
wherein determining an identification of the at least one entity further comprises determining the identification of the at least one of the plurality of entities selected through the received input.

11. The method according to claim 1, further comprising:
identifying at least one other entity that is related to the at least one entity; and
receiving information from the at least one other entity.

12. A mobile device for obtaining information pertaining to at least one entity connected to a network, said mobile device comprising:
a network interface;
a location aware device configured to automatically identify a location of the location aware device in a room containing a plurality of entities;
a location identification module configured to receive the identified location of the location aware device and to determine the identified location with respect to a map of the room, said map containing identifications and locations of the plurality of entities;
an entity identification module configured to determine an identification of at least one entity within a predetermined proximity of the location aware device based upon the position of the identified location with respect to the entities contained in the map; and
a network interface module configured to connect to the network through the network interface and to obtain information pertaining to the identified at least one entity over the network.

13. The mobile device according to claim 12, further comprising:
a controller configured to implement the location identification module, the entity identification module, and the network interface module; and
a memory on which is stored the map of the room, wherein the controller is configured to access the map in the memory to identify the location of the location aware device with respect to the map of the room.

14. The mobile device according to claim 13, further comprising:
an input source configured to receive input commands from a user, wherein the controller is configured to operate based upon the input commands received through the input source.

15. The mobile device according to claim 13, further comprising:
a display, wherein the controller is configured to display at least one of the information pertaining to the at least one entity and a graphical representation of the at least one entity on the display.

16. The mobile device according to claim 15, wherein the controller is further configured to receive an input from a user that identifies selection of at least one of the plurality of entities in a graphical representation of a plurality of entities on the display, and wherein the entity identification module is configured to determine the identification of the selected at least one of the plurality of entities.

17. The mobile device according to claim 12, further comprising:
an information retrieval module configured to identify at least one other entity that is related to the at least one entity and to receive information from the at least one other entity.

18. The mobile device according to claim 12, further comprising:
an orientation device configured to automatically determine an orientation of the orientation device, wherein the location identification module further comprises an orientation identification module configured to receive the determined orientation of the orientation device and to determine the orientation of the mobile device with respect to the map of the room, and wherein the entity identification module is further configured to determine the identification of the at least one entity based upon the determined orientation of the mobile device.

19. A computer readable storage medium on which is embedded one or more computer programs, said one or more computer programs implementing obtaining information with a mobile device pertaining to at least one entity in a room containing a plurality of entities, said at least one entity being connected to a network, said one or more computer programs comprising a set of instructions for:
identifying a location of the mobile device with respect to a map of the room, said map containing identifications and locations of the plurality of entities;
determining an identification of the at least one entity based upon a correlation of the identified location of the mobile device with respect to the map of the room;
connecting the mobile device to the network; and
obtaining information in the mobile device pertaining to the at least one entity through the connection with the network.

20. The computer readable storage medium according to claim 19, said one or more computer programs comprising a further set of instructions for:
determining the identification of the at least one entity based solely upon the identified location of the mobile device with respect to the map of the room.
